(19) United States
(12) Patent Application Publication
(10) Pub. No.: US 2008/0280639 A1
(43) Pub. Date: Nov. 13, 2008

(54) Multiple Line Cellular Telephone With Individual Features

(76) Inventor: Merav Alfia, Roslyn Heights, NY (US)

Correspondence Address: MICHAEL I KROLL, 171 STILLWELL LANE, SYOSSET, NY, 11791, US

(21) Appl. No.: 11/746,721

(22) Filed: May 10, 2007

(51) Int. Cl. H04M 1/02

(52) U.S. Cl. 455/551

(57) ABSTRACT

A cellular phone having two or more unique phone numbers with circuit means for simultaneously communicating with each of the lines. The cellular phone has at least two independent phone numbers with circuit means for differentiating between each of the lines incorporating a feature set for using each of the numbers so that a call can be received on one line while an indicator is actuated for a call on the other line and placing one of said calls on hold while answering a call on another line. The multi-line cellular phone has circuit means and memory for recording and playing prerecorded messages for each of the lines and for leaving messages on each of the lines an indicator means for as to which line is being used with the indicator taken from the list of audio indicator, visual indicator, vibratory indicator or any combination thereof.

### BACKGROUND OF THE INVENTION

1. Field of the Invention

The present invention relates generally to phones and, more specifically, to a cellular phone having two or more unique phone numbers with circuit means for simultaneously using each of the lines. In the preferred embodiment one of the lines would be used for business while the other would be used as a personal line.

The cellular phone of the present invention has at least two independent phone numbers with circuit means for differentiating between each of the lines which incorporate a feature set for each of the numbers.

The individual feature sets include having an auto answer function selectively providing having both lines open, one open with the other closed or both line closed, forwarding all calls to a message area, designating a period of time when all calls will be automatically forwarded to a message area. For instance, a second business number that is provided to other businesses and the general public may have incoming calls 24/7. The user may want to answer these calls if they are providing emergency services or direct those calls to another for emergency services or may want the caller to leave a message.

The present invention provides the user with the option of designating auto answer periods for a line where a user can be redirected to another number for emergency services or may leave a call back number. The cutoff periods and message capabilities of the present invention are only limited by the imagination of the user. As an example, both lines may be separate business ventures or typically one line is used by family and friends while another is for business.

The multi-line cellular phone has circuit means and memory for recording and playing prerecorded messages for each of the lines and for leaving messages on each of the lines and an indicator means as to which line is being used with the indicator taken from the list of audio indicator, visual indicator, vibratory indicator or any combination thereof.

Additional provided for are features pertaining to a particular line, such as appointment calendars for business and one for personal appointments.

2. Description of the Prior Art

There are other phone devices designed for multiple lines. Typical of these is U.S. Pat. No. 4,677,653 issued to Weiner et al. on Jun. 30, 1987.

Another patent was issued to Weiner et al. on Mar. 29, 1988 as U.S. Pat. No. 4,734,928. Yet another U.S. Pat. No. 5,408,525 was issued to Eldering on Apr. 18, 1995 and still yet another was issued on Dec. 31, 1996 to Sandler et al. as U.S. Pat. No. 5,590,185.

Another patent was issued to Akhaven on Sep. 30, 1997 as U.S. Pat. No. 5,673,308. Yet another U.S. Pat. No. 6,829,340 was issued to Wei on Dec. 7, 2004. Another was issued to Wynn on Aug. 15, 2006 as U.S. Pat. No. 7,092,386 and still yet another was issued on Mar. 6, 2007 to Palan as U.S. Pat. No. 7,187,946.

Another patent was issued to Koehler on Oct. 17, 2002 as German Patent No. DE10114649. Yet another U.S. Pat. No. DE1,034,0224 was issued to Romagholi on Mar. 24, 2005.

### U.S. Pat. No. 4,677,653

### Inventor: Sheldon Weiner et al.

### Issued: Jun. 30, 1987

An adapter for a cellular mobile phone unit which converts the unit to include a plurality of telephone numbers. A main circuit board is coupled to a microprocessor of the unit, which board includes a plurality of number assignment modules, or NAM's (ROM's), each NAM having its own unique telephone number code. The NAM's are connected such that fifteen of the sixteen pin-connections of each NAM are correspondingly and respectively connected in series, for coupling to the fifteen pin-connections of a plug at one end of a ribbon cable, the other end of the ribbon cable being coupled to the microprocessor of the unit via the conventional NAM connection therefor. Each remaining pin of each NAM, which is not connected in series, is connected to a unique stop of a multi-position switch, so that a selected one of the NAM's may be coupled to the microprocessor in order to change the telephone number from one to another. A secondary relay printed circuit board may also be provided to allow for remote switching from one NAM to another. The principles are also applicable to a personal computer's expansion slots, where a plurality of dedicated ROM chips may be selectively accessed by the microprocessor via the same address location.

### U.S. Pat. No. 4,734,928

### Inventor: Sheldon Weiner et al.

### Issued: Mar. 29, 1988

An adapter for a cellular mobile phone unit which converts the unit to permit simultaneous insertion of a plurality of telephone numbers. A main circuit board is coupled to a microprocessor of the unit, which board includes a plurality of number assignment modules, or NAM's (ROM's), each NAM having its own unique telephone number code. The NAM's are connected such that fifteen of the sixteen pin-connections of each NAM are correspondingly and respectively connected in series, for coupling to the fifteen pin-connections of a plug at one end of a ribbon cable, the other end of the ribbon cable being coupled to the microprocessor of the unit via the conventional NAM connection therefor. Each remaining pin of each NAM, which is not connected in series, is connected to a unique stop of a multi-position switch, so that a selected one of the NAM's may be coupled to the microprocessor in order to change the telephone number from one to another. A secondary relay printed circuit board may also be provided to allow for remote switching from one NAM to another. The principles are also applicable to a personal computer's expansion slots, where a plurality of dedicated ROM chips may be selectively accessed by the microprocessor via the same address location.

### U.S. Pat. No. 5,408,525

### Inventor: Charles A. Eldering

### Issued: Apr. 18, 1995

A diverter interfaces first and second telecommunication lines from first and second telecommunication sources, respectively, with a third line coupled to a station set. The diverter includes separate line and set monitors and a control unit. The line and set monitors monitor and detect predetermined selective signals such as (a) ringing signals propagating on the first and second lines, and (b) line access codes, flash hook, and line change requests signals generated by the station set. In response to the detected predetermined selective signals, the line and set monitors generate first, second, and third output control signals representative of the predetermined selective signals on the first, second, and third lines, respectively, to the control unit. The control unit, which is responsive to output signals from the line and set monitors, selectively couples a predetermined one of the first and second lines directly to the third line without interfering with the predetermined selective signals and states present on the first, second, and third lines. The control unit also generates predetermined output control signals to the line and set monitors for generating output signals such as call waiting signals for transmission to the station set on the third line. The diverter is powered from the first and second lines, and its actions remain invisible to and do not affect the first and second telecommunication sources and the station set.

### U.S. Pat. No. 5,590,185

### Inventor: Harold Sandler et al.

### Issued: Dec. 31, 1996

The present invention is a two line phone adaptor that allows two separate phone lines to be connected to and controlled by a single line DTMF phone. The two line phone adaptor has one ring detector for each line and one hold circuit for each line. The adaptor also has an electronic line selector circuit, a DTMF decoder and an off hook detector. All of the above circuits are connected to a micro controller that contains the software that defines the functions of the adaptor. The adaptor does not have any user accessible control buttons except for an on/off switch. The adaptor will automatically engage the ‘ringing line’ and transfer the ring signal to the attached phone to generate an audible ringing sound. When the phone is taken off the hook, the adaptor will automatically seize a ‘free line’ for use. The adaptor is controlled by the 3 times 4 keyboard of the attached DTMF single line phone and provides the functions such as music on hold, manual line select and three party conferences.

### U.S. Pat. No. 5,673,308

### Inventor: Hamid Akhavan

### Issued: Sep. 30, 1997

A Personal Communication System (PCS) is operated using a Personal Phone Number (PPN) associated with each portable subscriber station within the system. Each portable subscriber station has an associated “home” cordless telephone base station associated therewith. When a particular portable subscriber station is within a range of its home base station, that base station controls the transmission of a cellular call forwarding request to a cellular telephone system servicing that area. The cellular telephone function of the portable subscriber station is deactivated, and all incoming calls addressed to that particular PPN are routed over a telephone landline connected to the associated cordless telephone base station servicing the portable subscriber station. Upon leaving the range of communication of the associated cordless telephone base station, the portable subscriber station reactivates its own cellular telephone function so that communication can be carried out with the cellular telephone system servicing that area.

### U.S. Pat. No. 6,829,340

### Inventor: Tsung-Hsing Wei

### Issued: Dec. 7, 2004

The present invention disclosed a masked phone service, which depending on phone user's original phone number to virtually create multiple new corresponding substitutive phone numbers, called mask phone numbers; to mask phone user's original phone number when on demand; by adding this new created mask phone number, therefore, to make the phone user have at least two phone numbers on single phone device so that the phone user's original phone number and the mask phone number may be separately used for his working and private time respectively, and by this way the phone user's personal privacy is then improved.

### U.S. Pat. No. 7,092,386

### Inventor: Sol H. Wynn

### Issued: Aug. 15, 2006

One embodiment of the present invention includes a telephony interface, a network interface and a local area network (LAN). The telephony interface provides connectivity between one or more netphones and an external telephone network such as a PSTN telephone system. The network interface provides connectivity between one or more computers and an external computer network such as the Internet. The local area network provides interconnectivity between the netphone(s), the computer(s), the telephony interface and the network interface. In some embodiments, there may be two or more netphones which can communicate with each other internally via the LAN, in addition to communicating with the external telephone network. Similarly, there may be two or more computers that can also communicate with each other internally via the same LAN, in addition to the external computer network. By combining both the internal and external connectivity needs of both the netphone(s) and computer(s), the entry cost of installing both the netphone(s) and the computer(s) is dramatically lowered. In addition, once the network infrastructure has been installed, the existing netphone(s) and computer(s) can be very easily relocated within the network, and new netphone(s) and computer(s) can be added to the network with minimal changes to the network.

### U.S. Pat. No. 7,187,946

### Inventor: David B. Palan

### Issued: Mar. 6, 2007

A method and system for delivering wireless telephone service to landline customers via local loop telephone lines. Each of multiple local loop telephone lines will be interfaced with a respective wireless bridge at a point between a telephone company switch and the customer premises to which the local loop telephone line extends. Telephone equipment at the customer premises could then place and receive calls on the PSTN, and the wireless bridge will extend those calls to the PSTN via a wireless access network, thereby bypassing the ILEC's switching infrastructure.

### German Patent Number DE 10114649

### Inventor: Uwe Koehler

### Issued: Sep. 17, 2002

A method of selecting consignees in which incoming user/subscriber numbers and/or authorized information are compared with stored subscriber numbers to decide on further handling. A subscriber sets a filter via a control code and a short message service (SMS), or via the Internet, into the information control (SMSC) assigned to him, on the basis of his subscriber number identification or on the basis of a password, or according to the call, e-mail or WAP, which blocks incoming information already in the information control, or switches it thorough.

### German Patent Number DE 10340224

### Inventor: Hilmar Romagnoli

### Issued: Mar. 24, 2005

Multi-number mobile phone or mobile radio terminal has means for accepting two or more identification means, e.g. SIM cards, (2, 2′) with a control unit (1) that controls the signal path based on the selected and authenticated identification means. For an incoming call the control unit automatically activates the appropriate signal path, while for an outgoing call the user makes a selection as to which number is to be used.

While these phones may be suitable for the purposes for which they were designed, they would not be as suitable for the purposes of the present invention, as hereinafter described.

### SUMMARY OF THE PRESENT INVENTION

The multi-line cellular telephone of the present invention provides many advantages over a single line phone or having to carry two phones. Not the least of which is having to keep track of two phones and the maintenance of two phones, such as recharging, carrying two phones and differentiating between which is business and which is personal.

The ubiquitous cellular phone has become indespensible by providing roaming communication and many useful features that enable a user to receive a call, notification of a waiting call, holding one call while answering another, forwarding calls to a phone integral message center, video capture, Internet capabilities, music library, etc. but regardless of how many features a cell phone has it is still a single termination point in a network.

The present invention provides a cell phone that serves as a dual termination point within a network whereby a user can selectively assign one line for a desired service, such as a business while the other may serve as a personal line.

For example, if you work in real estate, salesperson, plumber, etc you know that hundreds of people get your cell number. Having a dual line phone with line one strictly for business provides that you can close line one at a predetermined time, such as 6 P.M. and whoever calls will leave a message on voicemail one. If you're a plumber that operates 24/7 you need that line open always and you know that every call you get on line one is very important. Line 2 would probably be as a personal line (a number given usually just to friends and family) So with a two line phone you can have both lines open, one open and the other closed, or both closed.

A primary object of the present invention is to provide a cellular phone having two or more unique phone numbers

Another object of the present invention is to provide a cellular phone that can simultaneously communicate with each of the additional lines.

Yet another object of the present invention is to provide a cellular phone having at least two independent phone numbers with circuit means for differentiating between each of the lines.

Still yet another object of the present invention is to provide a cellular phone having a feature set for using each of said unique numbers.

Another object of the present invention is to provide a cellular phone having circuit means for receiving a call on one line and circuit means for indicating an incoming call on the other line.

Yet another object of the present invention is to provide a cellular phone having circuit means for placing an incoming call on hold while answering a call on another line.

Still yet another object of the present invention is to provide a cellular phone having circuit means and memory for recording and playing prerecorded messages for each of the lines.

Another object of the present invention is to provide a cellular phone having circuit means and memory for leaving messages on each of the lines.

Yet another object of the present invention is to provide a cellular phone having circuit means and memory providing an indicator as to which line is being used.

Still yet another object of the present invention is to provide a cellular phone wherein said indicator is taken from the list of audio indicator, visual indicator, vibratory indicator or any combination thereof.

Another object of the present invention is to provide line specific features sets, such as an appointment calendar for the business line and an appointment calendar for personal appointments, which may include differentiating indicators whether audio, visual or vibratory as to what type of reminder whether business or personal.

Additional objects of the present invention will appear as the description proceeds.

The present invention overcomes the shortcomings of the prior art by providing a cellular phone having two or more unique phone numbers with circuit means for simultaneously communicating with each of the lines. The cellular phone has at least two independent phone numbers with circuit means for differentiating between each of the lines incorporating a feature set for using each of the numbers so that a call can be received on one line while an indicator is actuated for a call on the other line and placing one of said calls on hold while answering a call on another line. The multi-line cellular phone has circuit means and memory for recording and playing prerecorded messages for each of the lines and for leaving messages on each of the lines an indicator means for as to which line is being used with the indicator taken from the list of audio indicator, visual indicator, vibratory indicator or any combination thereof.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of prior art.

FIG. 2 is an illustrative view of prior art.

FIG. 3 is an illustrative view of the present invention in use.

FIG. 4 is a block diagram of the features of a multiple line cellular telephone of the present invention.

FIG. 5 is a flow chart of the multiple line cellular telephone of the present invention.

FIG. 6 is a block diagram of the features of a multiple line cellular telephone of the present invention.

FIG. 7 is a flow chart of the multiple line cellular telephone of the present invention.

FIG. 8 is a block diagram of the features of a multiple line cellular telephone of the present invention.

### DESCRIPTION OF THE REFERENCED NUMERALS

Turning now descriptively to the drawings, in which similar reference characters denote similar elements throughout the several views, the figures illustrate the Multi-Line Cellular Telephone of the present invention. With regard to the reference numerals used, the following numbering is used throughout the various drawing figures.

10 Multi-Line Cellular Telephone of the present invention

12 cellular phone of 10

14 first memory module

15 second memory module

16 user

18 caller 1

20 caller 2

22 prior art

24 cell phone of 22

26 multiple line feature set

28 individual ring tone

30 speed dialing

32 message center

34 calendar

36 appointment schedule

38 conference calling

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

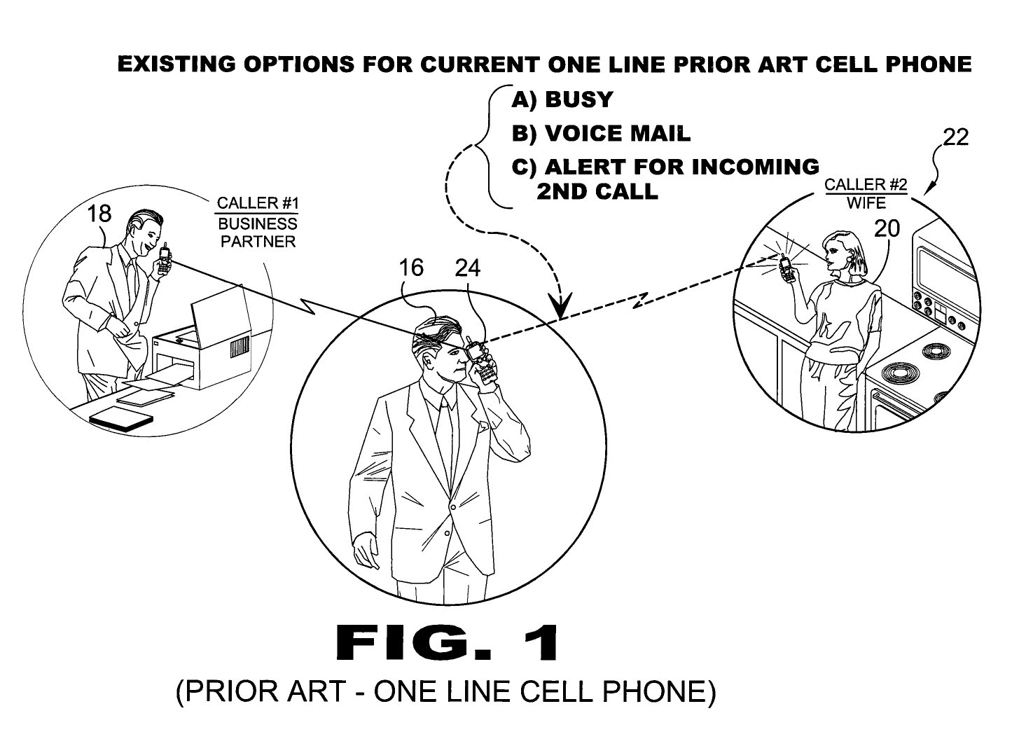

FIG. 1 is an illustrative view of prior art 22. Under present conditions, cellular phones 26 allow only one call access per cellular phone 26 number, other incoming calls are directed to missed call or answering service. Shown is the user 16 unable to receive a call from caller “2” 20 because of being on the line with caller “1” 18. The present invention overcomes this problem by providing a cell phone having at least two telephone numbers accessible by the user in combination with distinctive feature sets for each number. The individual feature sets include having an auto answer function selectively providing having both lines open, one open with the other closed or both line closed, forwarding all calls to a message area, designating a period of time when all calls will be automatically forwarded to a message area.

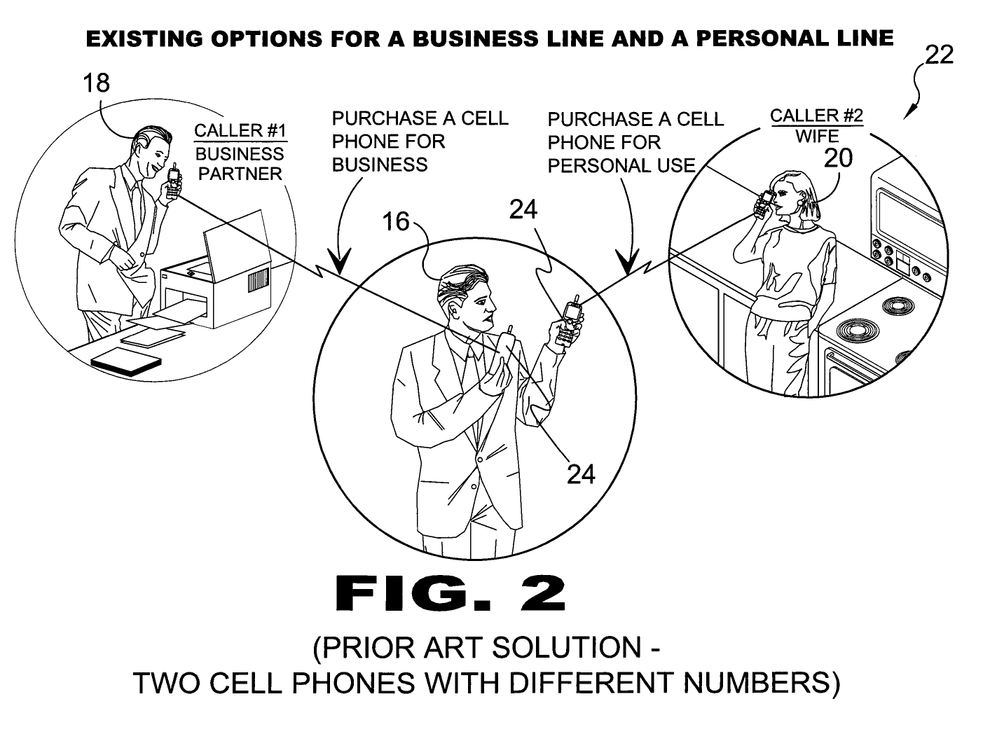

FIG. 2 is an illustrative view of prior art 22. Under present conditions, cellular phones 26 allow only one call number access per cellular phone 26 number, other incoming calls are directed to missed call or answering service. Shown is the user 16 unable to receive a call from caller “2” 20 because of being on the line with caller “1” 18. Prior to the present invention, a cellular phone user 16 would need two telephones to have immediate contact with more than one caller and distinguish between the nature of the calls. The present invention overcomes this problem by providing a cell phone having distinctive memory modules for storing and receiving each feature set with separate phone numbers. The multi-line cell phone feature sets include individual ring tones, speed dialing, message centers, calendars and appointment schedules.

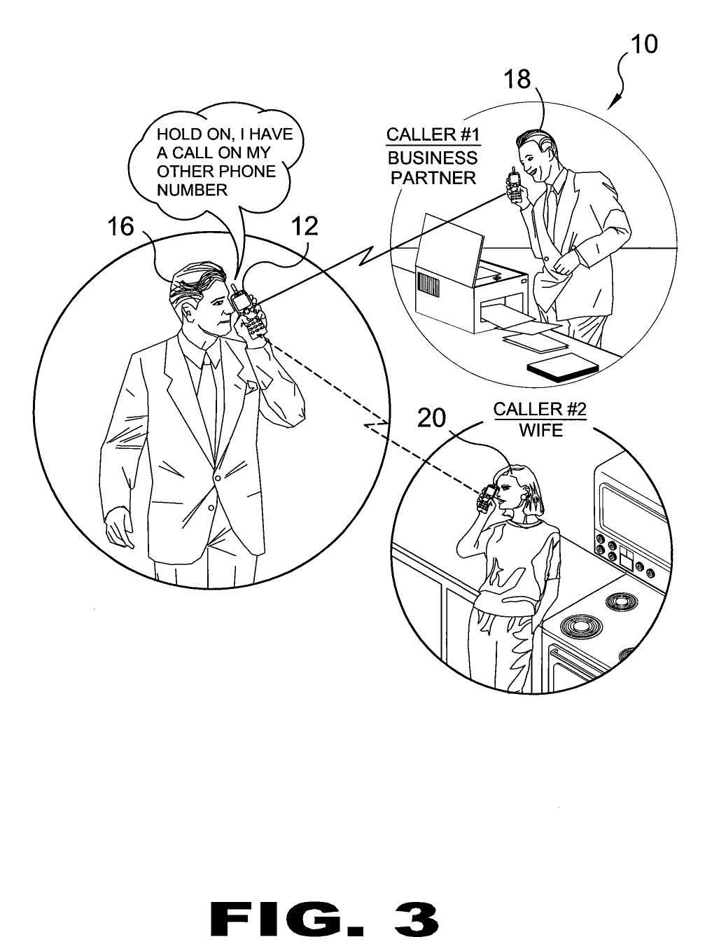

FIG. 3 is an illustrative view of the present invention 10 in use. The present invention 10 is a cellular phone 12 having at least two telephone numbers accessible by the user 16 in combination with distinctive feature sets for each number. The cell phone 12 provides distinctive memory modules for storing and retrieving each feature set. The multi-line cell phone 12 feature sets include individual ring tones, speed dialing, message centers, calendars and appointment schedules and enables the user 16 to speak with a first caller 18 and a second 20 calling different numbers that may have different ring tones thereby differentiating between the nature of the incoming calls. The individual feature sets include having an auto answer function selectively providing having both lines open, one open with the other closed or both line closed, forwarding all calls to a message area, designating a period of time when all calls will be automatically forwarded to a message area.

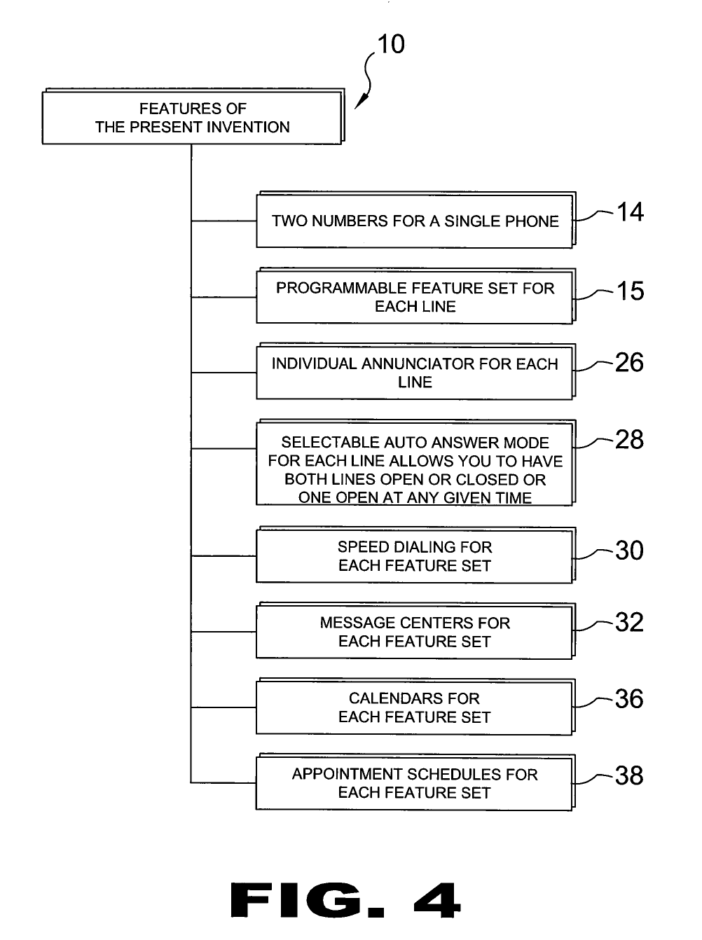

FIG. 4 is a block diagram of the features of a multiple line cellular telephone of the present invention 10. The present invention, a multiple line cellular telephone, provides a user with distinctive and individual memory modules 14,15 with their own feature sets 26 including individual ring tones 28, speed dialing 30, message centers 32, calendars 34, conference calling 38 and appointment schedules 36.

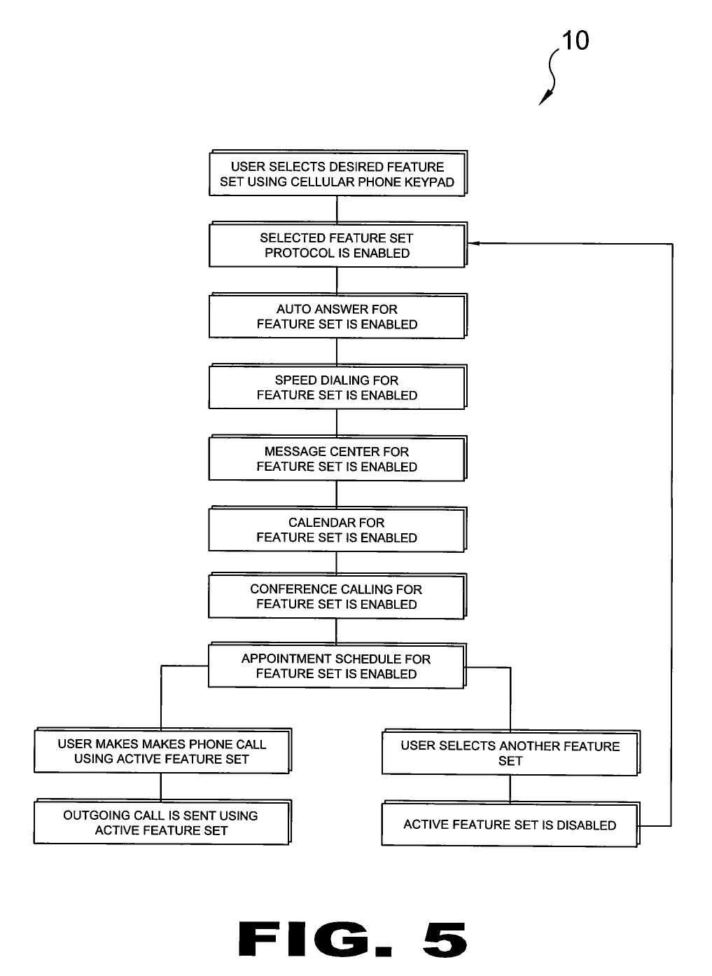

FIG. 5 is a flow chart of the multiple line cellular telephone of the present invention 10. The present invention 10, a multiple line cellular telephone, provides a user with distinctive and individual memory modules and feature sets that allows the user to have a least two telephone numbers accessible for incoming and outgoing calls.

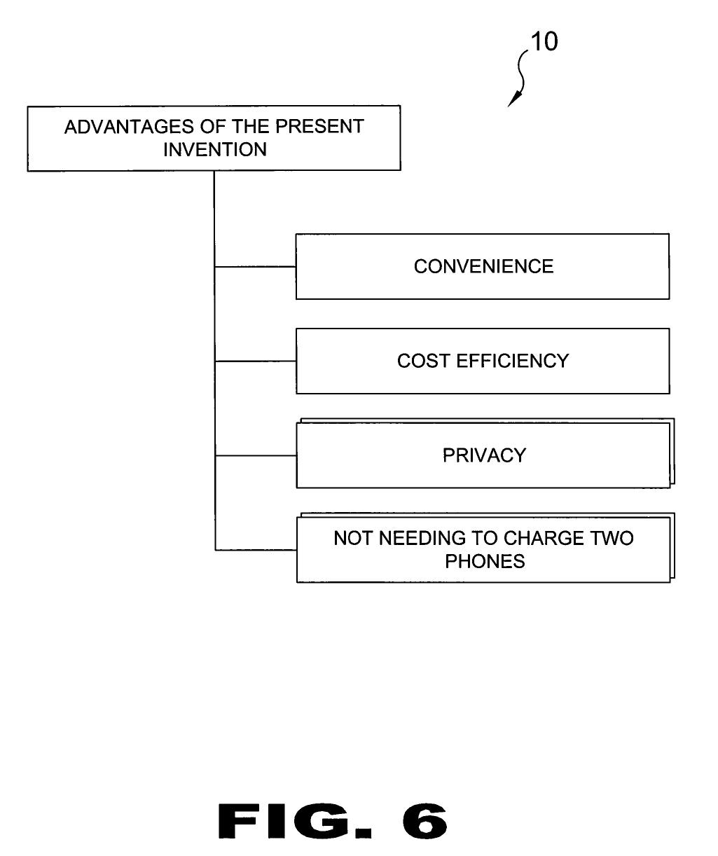

FIG. 6 is a block diagram of the features of a multiple line cellular telephone of the present invention 10. The block diagram demonstrate the advantages of the present invention 10 including cost efficiency, convenience and privacy.

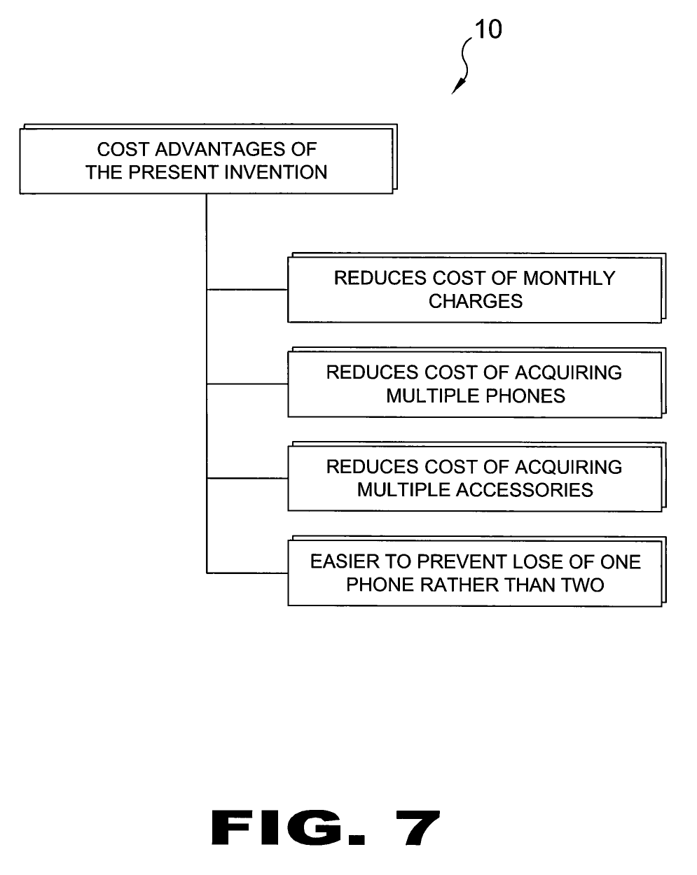

FIG. 7 is a flow chart of the multiple line cellular telephone of the present invention 10. The flow chart presents the advantages of the present invention 10 including the reduction of monthly charges, reducing the cost of purchasing multiple phones and reducing the cost of acquiring multiple accessories.

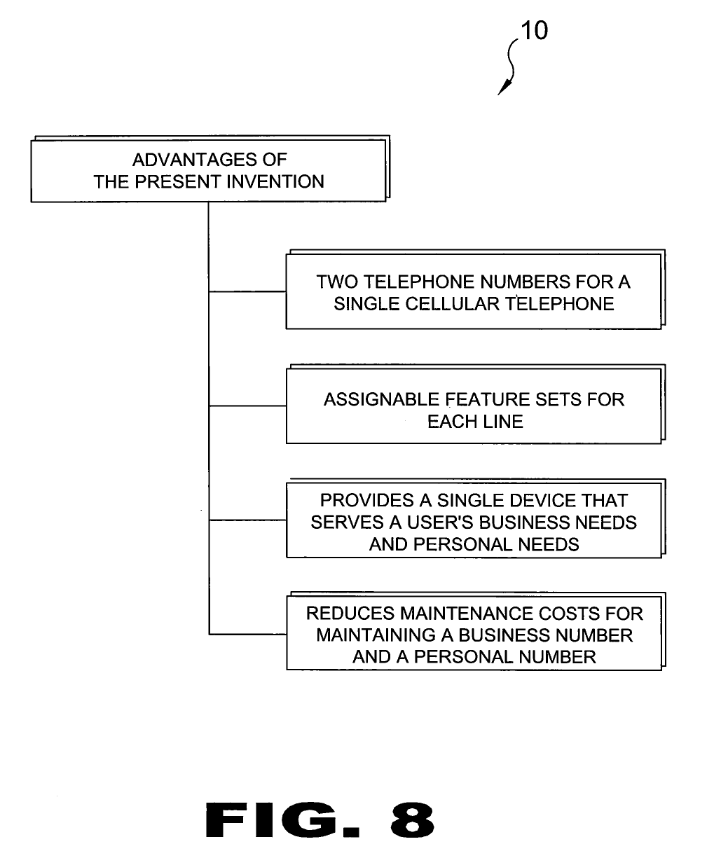

FIG. 8 is a block diagram of the features of a multiple line cellular telephone of the present invention 10. The present invention 10 provides advantages over the prior art by eliminating the need to carry multiple cell phones, reducing the amount of accessories needed and reducing the need for recharging multiple batteries.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims.

1. A multi-line cellular telephone having a plurality of phone numbers enabling the user to differentiate between the nature of an incoming call depending upon the number that is being called, said multi-line cellular phone comprising:
a) a cellular telephone;
b) a plurality of memory modules disposed with said cell phone; and
c) a plurality of feature and function sets independent to each said memory module.

2. The multi-line cellular telephone recited in claim 1, wherein each said memory module has a separate phone number for transmitting and receiving phone calls to and from said cell phone.

3. The multi-line cellular telephone recited in claim 2, wherein said user is capable of receiving a call to one phone number on said cellular phone while speaking on a line with anther assigned number on the same said phone.

4. The multi-line cellular telephone recited in claim 1, wherein said memory modules may be set to have separate ring tones to enable the user to determine the nature of the incoming call without looking at the digital display.

5. The multi-line cellular telephone recited in claim 4, wherein a first memory module is used for business and a second memory module is used for personal calls.

6. The multi-line cellular telephone recited in claim 5, wherein each said memory module has its own phone book.

7. The multi-line cellular telephone recited in claim 6, wherein each said memory module is programmed for its individualized speed dialing.

8. The multi-line cellular telephone recited in claim 1, wherein each said memory module includes its own message center to receive messages from their respective incoming calls.

9. The multi-line cellular telephone recited in claim 8, wherein said message centers of each said memory module have independent voice mail.

10. The multi-line cellular telephone recited in claim 9, wherein said message centers of each memory module have individual text messaging.

11. The multi-line cellular telephone recited in claim 1, wherein each said memory module includes and independent calendar.

12. The multi-line cellular telephone recited in claim 1, wherein each said memory module further includes an independent appointment scheduling feature.

13. The multi-line cellular telephone recited in claim 1, wherein said cellular phone includes cross conference call capabilities between the assigned phone numbers of each said memory module.

14. The multi-line cellular telephone recited in claim 1, wherein each said memory module can store a separate voice message from the user for calls that are not picked up.
